(19) United States
(12) Patent Application Publication
(10) Pub. No.: US 2005/0088513 A1
(43) Pub. Date: Apr. 28, 2005

(54) Open-to-view video telephony call in a wireless communication device

(76) Inventors: Gary J. Oswald, Elk Grove, IL (US); Rafael Camargo, Mundelein, IL (US); Vikram Kapoor, Round Lake, IL (US)

Correspondence Address: MOTOROLA INC, 600 NORTH US HIGHWAY 45, ROOM AS437, LIBERTYVILLE, IL, 60048-5343, US

(21) Appl. No.: 10/692,987

(22) Filed: Oct. 24, 2003

(51) Int. Cl. H04N 7/14

(52) U.S. Cl. 348/14.02; 348/14.03

(57) ABSTRACT

A method (200) and an apparatus (400) for a wireless portable communication device (104) having a video telephony communication capability for responding to an incoming call are provide. The wireless portable communication device detects the incoming call and determines whether the incoming call is a video telephony call. If the incoming call is a video telephony call, then the wireless portable communication device configures itself for video telephony communication. Then upon receiving a single input signal, the wireless portable communication device activates required video functions and completes the incoming call.

### FIELD OF THE INVENTION

The present invention generally relates to a wireless portable communication device equipped with a camera, more specifically to a method and apparatus for a wireless portable communication device equipped with a camera for completing a video telephony call.

### BACKGROUND OF THE INVENTION

Portable communication devices, such as cellular telephones, personal digital assistants (“PDAs”), and pagers, have become very popular and common. More recently, portable communication devices having video capability, typically equipped with color screens and built-in or attachable cameras, are becoming increasingly popular. Such devices are generally capable of transmitting, receiving, and communicating audio, text, and video messages. For example, a portable communication device such as a cellular telephone having video capability can receive a video telephony call, and display the video portion and play the audio portion as well as transmit video images and audio message such that the caller and the call recipient can have video communication. However, the acceptance of a video telephony call by the cellular telephone equipped with video capability is currently handled manually. A user of a cellular telephone having video capability can choose to accept the video telephony call as voice-only call by manually placing the cellular telephone in a voice-only mode. If the user desires to accept the incoming video telephony call to establish video communication, the user must first accept the incoming video telephony call, and then place the cellular telephone in the video telephony mode to establish video communication.

### BRIEF DESCRIPTION OF THE DRAWINGS

FIG. 1 is an exemplary block diagram of an environment where the present invention may be practiced;

FIG. 2 is an exemplary flowchart for a first embodiment in accordance with the present invention of a method in a wireless portable communication device having a video telephony communication capability for responding to an incoming call;

FIG. 3 is an exemplary block diagram illustrating single user input signal generation of block 210 of FIG. 2; and

FIG. 4 is an exemplary block diagram of an apparatus for the wireless portable communication device.

### DETAILED DESCRIPTION OF THE PREFERRED EMBODIMENTS

The present invention relates to a method and an apparatus for a wireless portable communication device, which defaults to a video telephony mode and completes an incoming video telephony call based upon a single action from a user.

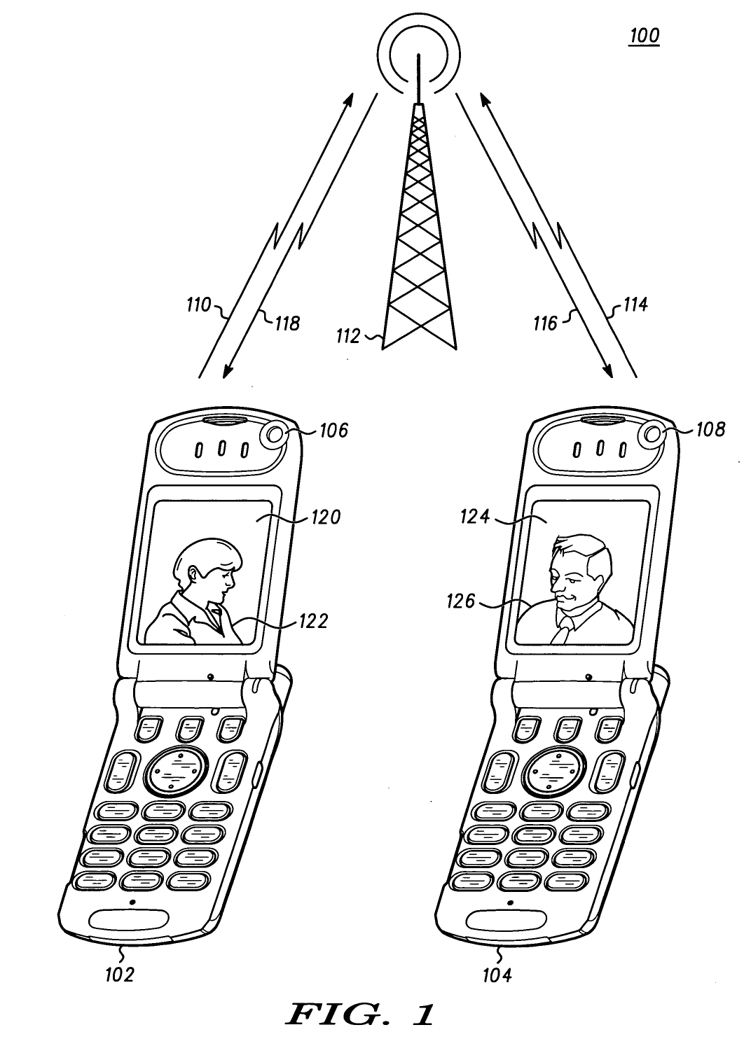

FIG. 1 is an exemplary block diagram 100 of an environment where the present invention may be practiced. In this exemplary environment, there are two cellular telephones, a first cellular telephone 102 and a second cellular telephone 104, both of which have video telephony capability and are equipped with cameras 106 and 108, respectively. The first cellular telephone initiates a video telephony call to the second cellular telephone 104 by transmitting a first signal 110 to a local base station 112, which then transmits a first base signal 114 to the second cellular telephone 104. If the second cellular telephone 104 accepts the video telephony call from the first cellular telephone 102, then the video telephony call is completed. The second cellular telephone 104 communicates with the first cellular telephone by transmitting a second signal 116 to the local base station 112, which then transmits a second base signal 118 to the first cellular telephone 102. The first cellular telephone 102 then displays on its display 120 an image 122 transmitted from the second cellular telephone 104, and the second cellular telephone 104 then displays on its display 124 an image 126 transmitted from the first cellular telephone 102.

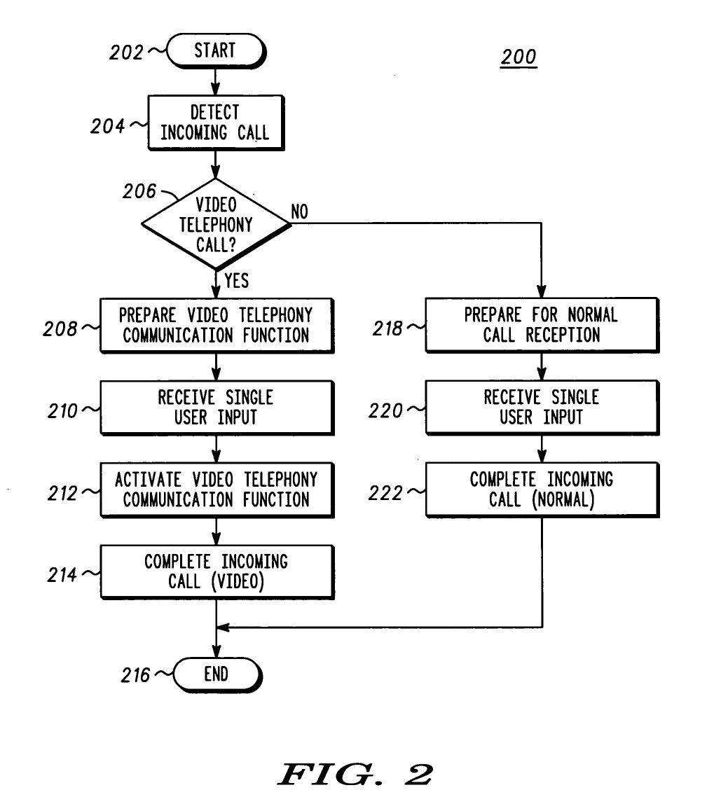

FIG. 2 is an exemplary flowchart 200 for a first embodiment in accordance with the present invention of a method in a wireless portable communication device having a video telephony communication capability for responding to an incoming call. Currently, a user of a video telephony communication capable device is required to first accept an incoming video telephony call and then place the device in the video telephony mode to establish video communication. However, the present method enables a user to place the portable communication device in a video telephony mode in response to an incoming video telephony call, and to complete the incoming video telephony call with minimal effort, i.e. a single action of the user. The process begins in block 202, and the wireless portable communication device 104 detects the incoming call 114 in block 204. If the wireless portable communication device 104 determines that the incoming call is a video telephony call in block 206, then the wireless portable communication device 104 prepares a video telephony communication function that is compatible with the incoming call in block 208 by setting certain parameters. The wireless portable communication device 104 may further determine whether the incoming call is a multimedia message service call in block 206, and may prepare to begin playing a multimedia message included in the incoming. For example, the preparation may involve setting video resolution, video speed such as number frames per second, and audio quality such as monaural, stereo, and loudness. Because the video telephony call generally involves the user to view the images received, the wireless portable communication device 104 may be set to default to a speaker-phone mode upon accepting the incoming video telephony call unless presence of a headset is detected. These parameters include parameters for both receiving the incoming video telephony call and transmitting a video telephony call using a camera, which may be built-in or externally attached to the wireless portable communication device 104. Some of these parameters may be dictated by a service contract for the wireless portable communication device 104 or by capability of a network in which the wireless portable communication device 104 is currently registered. However, other parameters may be based upon a user preference programmed into the wireless portable communication device 104, and may be changed during the video telephony call. In block 210, the wireless portable communication device 104 receives a single action user input signal, which activates in block 212 the video telephony communication function prepared in block 208. The single action user input signal further causes the wireless portable communication device 104 to complete the incoming video telephony call in block 214 by accepting the incoming call and by beginning to transmit a return video telephony call. If the incoming call has been determined to be a multimedia message service call including a multimedia message in block 206, then the wireless portable communication device 104 may also begin playing the multimedia message in block 212 upon completing the incoming call. The process then terminates in block 216.

If the wireless portable communication device 104 determines that the incoming call is not a video telephony call in block 206, then the wireless portable communication device 104 prepares for a normal call reception in block 218. Upon receiving the single action user input signal in block 220, the wireless portable communication device 104 completes the incoming call in 222, and the process terminates in block 216.

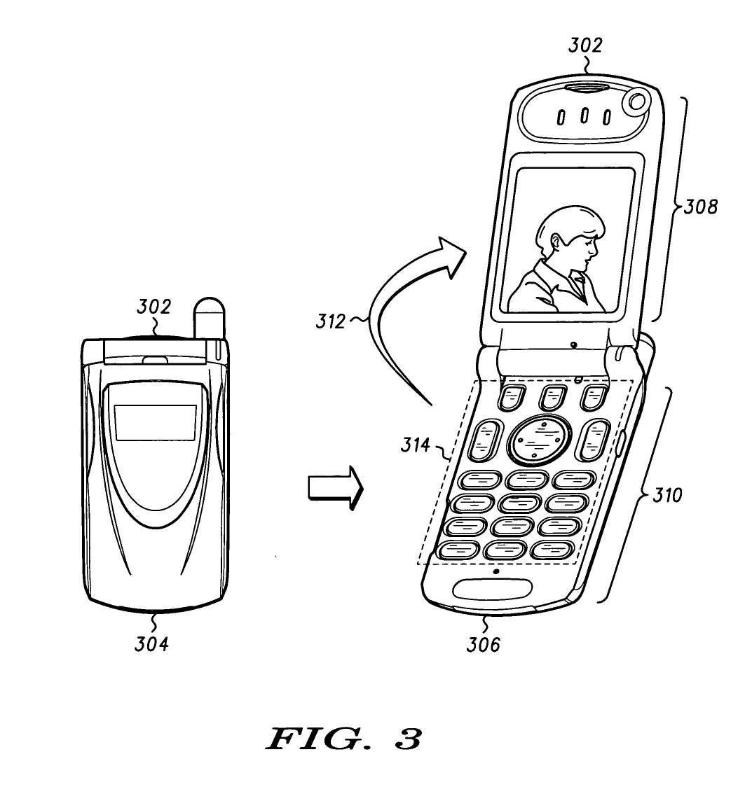

The single action user input signal received in block 210 by the wireless portable communication device 104 may be generated in various ways. In FIG. 3, a wireless portable communication device 302, which is foldable, is shown in a closed position 304 and in an opened position 306. The single action user input signal can be generated in response to changing the position of the wireless portable communication device 302 from the closed position 304 to the opened position 306 by opening a first housing 308 away from a second housing 310 as indicated by an arrow 312. The single action user input signal may also be generated by an actuation of a key of a key pad 314 comprising a plurality of keys of the wireless portable communication device 302. For example, if the wireless portable communication device 302 was already in the opened position 306, then a simple push of a button is preferable rather than requiring the wireless portable communication device 302 to be closed and then to be opened. Further, if the wireless portable communication device 302 received an incoming video telephony call while communicating in a normal call mode, then the user would be able to switch to the incoming video telephony call by simply pressing a key on the key pad 314. Generating the single action user input signal by using a key of a wireless portable communication device may be necessary for a wireless portable communication device that lacks closed and opened positions.

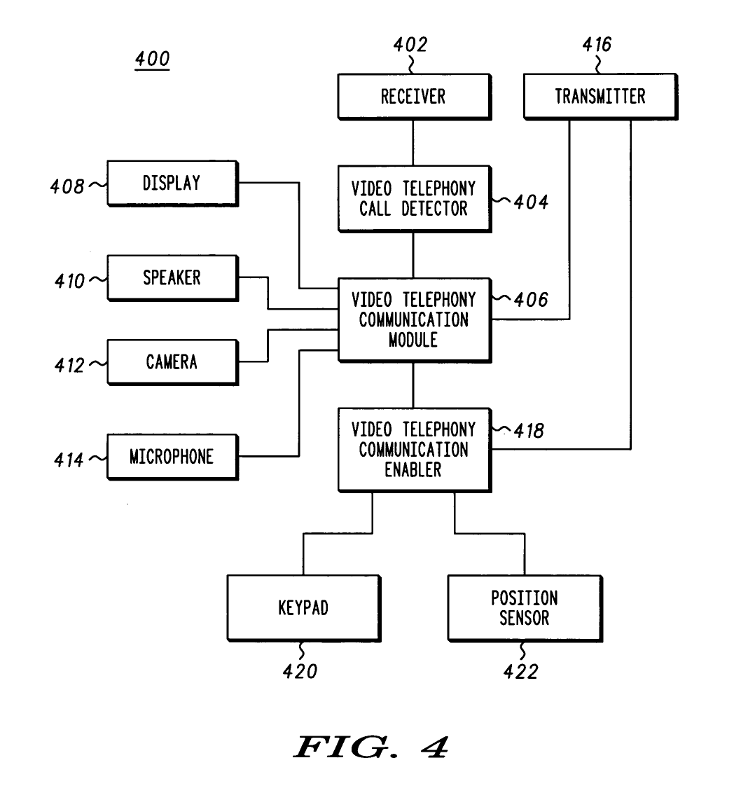

An exemplary block diagram 400 of an apparatus for the wireless portable communication device 104 is provided in FIG. 4. A receiver 402, which is configured to receiver an incoming call, is coupled to a video telephony call detector 404. The video telephony call detector 404 is configured to determine whether the incoming call is a video telephony call, and is also coupled to a video telephony communication module 406. The video telephony communication module 406 is configured to process the incoming call properly based upon the characteristics of the incoming call. For example, if the video telephony detector 404 determined that the incoming call was a video telephony call, then the video telephony communication module 406 would process the incoming call as a video telephony call by accessing appropriate video functions. Whereas if the video telephony detector 404 determined that the incoming call was a voice call, then the video telephony communication module 406 would process the incoming call as a voice call, and might bypass the video functions.

To communicate the incoming call to a user and to capture information from the user to be transmitted, several interface devices are coupled to the video telephony communication module 406. A display 408 and a speaker 410 are coupled to the video telephony communication module 406. The display 408 is configured to display a video portion of the incoming call, and may be a liquid crystal display (“LCD”), a plasma screen, a projector capable of displaying images on a separate screen, or any other displaying mechanism. The speaker 410 is configured to audibly play an audio portion of the incoming call. Alternatively, the wireless portable communication device 104 may lack the speaker 410, such as a physically built-in speaker, but may have an audio circuit capable of supporting an external speaker such as an earphone. The display 408 may be further configured to display texts such as a text message associated with one or both of the incoming call and a return response. A camera 412 and a microphone 414 are also coupled to the video telephony communication module 406. The camera 412 is configured to capture images to be transmitted and the microphone 414 is configured to capture audio to be transmitted. A transmitter 416 is also coupled to the video telephony communication module 406, and is configured to transmit a transmission communication signal including any required information to complete and establish communication and the captured images and audio. To enable processing of the incoming call and transmission of the transmission communication signal, there is a video telephony communication enabler 418, which is coupled to the video telephony communication module 406 and to the transmitter 416. The video telephony communication enabler 418 is configured to accept an enabler input signal after the video telephony call detector 404 has determined the incoming call is a video telephony call, and enables the video telephony communication module 406 to process the incoming call as a video telephony call. Upon receiving the enabler input signal, the video telephony communication enabler 418 further enables the response signal, which is transmitted by the transmitter 416 to include the captured video and audio.

The enabler input signal may be generated in various ways. For example, the enabler input signal may be generated by actuating a key of a key pad 420 coupled to the video telephony communication enabler 418. For a wireless portable communication device capable of having opened and closed positions, such as a foldable cellular telephone, a position sensor 422 may generate the enabler input signal based upon a detected position. For example, the position sensor 422, which is coupled to the video telephony communicator enabler 418, can generate the enabler input signal based on a relative position of a first housing to a second housing between the opened position and the closed position as previously shown in FIG. 3 for the foldable cellular telephone 302 having the first housing 308 and the second housing 310. Other examples of a wireless portable communication device capable of having an opened and closed positions include a flip-type cellular telephone covering a portion of the cellular telephone with a flip, and slidable cellular telephone covering a portion of the cellular telephone with a slidable cover. The position sensor 422 can similarly detect the position of the flip for the flip-type cellular telephone and the position of the slidable cover of the slidable cellular telephone between the opened position and the closed position to generate the enabler input signal.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. A method in a wireless portable communication device having a video telephony communication capability for responding to an incoming call, the method comprising:
detecting the incoming call;
determining whether the incoming call is a video telephony call;
configuring the wireless portable communication device for video telephony communication upon determining the incoming call is a video telephony call;
receiving a single user action signal;
completing the incoming call; and
processing the incoming call as a video telephony call,
wherein the single user action signal effectuates both completing the incoming call and processing the incoming call as a video telephony call.

2. The method of claim 1, wherein:
the wireless portable communication device comprises first and second housings which move relative to each other between a closed position and an opened position; and
the single user action signal is generated upon moving the first and second housings relative to each other from the closed position to the opened position.

3. The method of claim 1, wherein the single user action signal is generated upon actuating a key of a user interface of the wireless portable communication device.

4. The method of claim 1, wherein configuring the wireless portable communication device for video telephony communication further comprises:
setting video and audio quality based upon a preselected user preference.

5. The method of claim 4, further comprising:
allowing the preselected user preference to be modified after receiving the incoming call.

6. The method of claim 1, wherein completing the incoming call includes activating at least one of:
a built-in camera of the wireless portable communication device, and
an external camera attached to the wireless portable communication device.

7. The method of claim 6, further comprising:
capturing an image by at least one of the built-in camera and the external camera; and
transmitting the captured image upon receiving the single user action signal.

8. The method of claim 1, further comprising:
determining whether the incoming call is a multimedia message service call; and
playing a multimedia message included the incoming call upon completing the incoming call.

9. A method in a wireless portable communication device having a video telephony communication capability and equipped with a camera for responding to an incoming video telephony call, the method comprising:
detecting the incoming video telephony call;
configuring the wireless portable communication device for video telephony communication;
receiving an activation signal generated by a single user action;
completing the incoming video telephony call; and
processing the incoming video telephony call,
wherein the activation signal effectuates both completing the incoming call and processing the incoming video telephony call.

10. The method of claim 9, further comprising
providing first and second housings of the wireless portable communication device, the first and second housings move relative to each other between a closed position and an opened position,
wherein the activation signal is generated by the single user action of moving the first and second housings relative to each other from the closed position to the opened position.

11. The method of claim 9, wherein the activation signal generated by a single user action is generated by actuating a key of a user interface of the wireless portable communication device.

12. The method of claim 9, wherein configuring the wireless portable communication device for video telephony communication further comprises:
setting video and audio quality based upon a preselected user preference.

13. The method of claim 12, further comprising:
allowing the preselected user preference to be modified after receiving the incoming video telephony call.

14. The method of claim 9, wherein the camera is at least one of:
a built-in camera of the wireless portable communication device, and
an external camera attached to the wireless portable communication device.

15. The method of claim 14, further comprising:
capturing an image by the camera; and
transmitting the captured image upon receiving the activation signal.

16. The method of claim 9, further comprising:
determining whether the incoming video telephony call is a multimedia message service call; and
playing a multimedia message included the incoming video telephony call upon completing the incoming call.

17. A wireless portable communication device having a video telephony communication capability comprising:
a video telephony call detector configured to determine whether an incoming call is a video telephony call;
a video telephony communication module coupled to the video telephony call detector, the video telephony communication module configured to process the incoming call; and
a video telephony communication enabler coupled to the video telephony communication module, the video telephony communication enabler configured to accept an enabler input signal after the video telephony call detector has determined the incoming call is a video telephony call,
wherein the enabler input signal is generated based upon a single action performed upon the wireless portable communication device, and
wherein upon receiving the enabler input signal, the video telephony communication enabler enables the video telephony communication module to complete and process the incoming call as a video telephony call.

18. The wireless portable communication device of claim 17, further comprising:
a camera coupled to the video telephony communication module, the camera configured to capture images to be transmitted;
a microphone coupled to the video telephony communication module, the microphone configured to capture audio to be transmitted; and
a transmitter coupled to the video telephony communication module, the transmitter configured to transmit a transmission communication signal including the captured images and audio,
wherein the video telephony communication enabler is further coupled to the transmitter, and upon receiving the enabler input signal, the video telephony communication enabler further enables the transmitter to transmit the transmission communication signal including the captured images and audio.

19. The wireless portable communication device of claim 18, further comprising:
a first housing including at least the video telephony call detector; and
a second housing coupled the first housing,
wherein the first and second housings are configured to move relative to each other between a closed position and an opened position, and
wherein the enabler input signal is generated upon moving the first and second housings relative to each other from the closed position to the opened position if the video telephony call detector determines the incoming call is a video telephony call.

20. The wireless portable communication device of claim 18, further comprising a keypad having a plurality of keys,
wherein the enabler input signal is generated upon actuating a key of the plurality of keys of the key pad if the video telephony call detector determines the incoming call is a video telephony call.

21. The wireless portable communication device of claim 20, further comprising a display coupled to the video telephony communication module,
wherein the key pad is further configured to generate a text message to be transmitted as part of the transmission communication signal, and the display is further configured to display at least one of:
the text message;
a text portion of the incoming call; and
the captured images to be transmitted.
